(19) United States
(12) Patent Application Publication
(10) Pub. No.: US 2011/0221576 A1
(43) Pub. Date: Sep. 15, 2011

(54) INFORMATION PROCESSING APPARATUS, WIRELESS TAG READING APPARATUS, AND WIRELESS TAG READING METHOD

(75) Inventor: Yuya Itagaki, Shizuoka (JP)

(73) Assignee: TOSHIBA TEC KABUSHIKI KAISHA, Tokyo (JP)

(21) Appl. No.: 13/044,729

(22) Filed: Mar. 10, 2011

(30) Foreign Application Priority Data
Mar. 11, 2010 (JP) 2010-055061

(51) Int. Cl. H04Q 5/22

(52) U.S. Cl. 340/10.4

(57) ABSTRACT

There are provided a reading unit emitting radio waves to a predetermined region and reading information from wireless tags responding to the radio waves; an output level control unit changing output levels of the radio waves emitted by the reading unit to values corresponding to the plural kinds of wireless tags with different response distances; a storage unit storing a table in which the output levels validating the information read from the wireless tags are associated as valid outputs with respective kinds of wireless tag; and a selection unit selecting the information read from the respective wireless tags based on the kinds of wireless tags communicating with the reading unit using the radio waves of the output levels and the valid outputs of the respective kinds of wireless tags stored in the table.

### CROSS-REFERENCE TO RELATED APPLICATION

This application claims the benefit of priority from Japanese Patent Application No. 2010-55061, filed on Mar. 11, 2010, the content of which is incorporated herein by reference.

### FIELD

The present invention relates to an information processing apparatus reading a wireless tag, a wireless tag reading apparatus, and a wireless tag reading method.

### BACKGROUND

Conventionally, there is known a goods sale system in which a POS (Point Of Sales) terminal processes goods sale registration using an RFID (Radio Frequency Identification) technique. A wireless tag (RFID tag) used in such a system can store a larger amount of information compared to a bar code. Moreover, the advantage of achieving good processing efficiency can be obtained since data can be read en bloc by using a method called anti-collision (collision prevention) in a control of communication with a reader and writer, although there are a plurality of RFID tags within a communicable range of one reader and writer.

Accordingly, there was suggested a technique for reading goods information en block from the RFID tags of respective goods put in a register counter by attaching the RFID tag, in which goods information such as a goods identification code or a price is written, to each of the goods and embedding an antenna of a reader and writer communicable with the RFID tag in the register counter in retail stores or the like.

The kinds of RFID tags are various and are classified for use according to the kinds of goods attached with the RFID tags. For example, in apparel stores, a standard RFID tag (hereinafter, referred to as a standard tag) is attached to a typical clothing. When the standard tag is attached to a small-sized accessory such as a ring or a piercing, the standard tag becomes large in relation to the accessory and thus presentation becomes poor. Therefore, an RFID tag (hereinafter, referred to as a small-sized tag) smaller than the standard tag is attached.

In general, the standard performances of the RFID tags are different according to the kinds thereof. For example, a distance (hereinafter, referred to as a response distance) in which a small-sized tag can respond is smaller than the response distance of a standard tag for radio waves with a predetermined strength output from the reader and writer in the above example. When the RFID tags with different response distances are used together, there is a possibility that all of the RFID tags present within a predetermined reading range (for example, a register counter) may not be read due to a difference in the response distance or an unnecessary RFID tag in the periphery of the reading range may be read on the assumption that the transmission output from the reader and writer has a constant level. In this case, since it is necessary to change the arrangement positions of the goods, a problem may arise in that processing efficiency deteriorates.

According to an aspect of the invention, an information processing apparatus includes: a reading unit emitting radio waves to a predetermined region and reading information from wireless tags responding to the radio waves; an output level control unit changing output levels of the radio waves emitted by the reading unit to values corresponding to the plural kinds of wireless tags with different response distances; a storage unit storing a table in which the output levels validating the information read from the wireless tags are associated as valid outputs with respective kinds of wireless tag; and a selection unit selecting the information read from the respective wireless tags based on the kinds of wireless tags communicating with the reading unit using the radio waves of the output levels and the valid outputs of the respective kinds of wireless tags stored in the table.

According to another aspect of the invention, a wireless tag reading apparatus includes: an antenna emitting radio waves including a signal used to read information maintained in wireless tags to a predetermined region which is a reading target; a switching unit switching output levels of the radio waves emitted from the antenna into a plurality of stages; a reading unit reading information via the antenna from each of the wireless tags responding to the respective radio waves with the output levels; and a list generation unit generating a list in which the information read by the reading unit is associated with the output levels used to read the information.

According to still another aspect of the invention, a wireless tag reading method executed in an information processing apparatus includes a reading unit which emits radio waves to a predetermined region and reads information from wireless tags responding to the radio waves. The method includes: changing output levels of the radio waves emitted by the reading unit into values corresponding to the plural kinds of wireless tags with different response distances; and selecting the information read from the respective wireless tags based on a table, in which the output levels validating the information read from the wireless tags are associated as valid outputs with the respective kinds of wireless tags, and the kinds of wireless tags communicating with the reading unit using the radio waves of the output levels.

### DESCRIPTION OF THE DRAWINGS

FIG. 1 is a diagram illustrating the overall configuration of a goods sale system as an information processing system according to an embodiment of the invention.

FIG. 2 is a diagram illustrating an example of a goods master table stored by a store server.

FIG. 3 is a diagram illustrating an example of a section code table stored by the store server.

FIG. 4 is a diagram illustrating the overall configuration of a POS terminal.

FIG. 5 is a diagram illustrating the configuration of an RFID tag reader and writer according to a first embodiment.

FIG. 6 is a diagram illustrating the arrangement position of an antenna included in the RFID tag reader and writer.

FIG. 7 is a diagram illustrating the configuration of an RFID tag.

FIG. 8 is a diagram illustrating an example of data stored in the RFID tag.

FIG. 9A is a diagram illustrating a relationship between the reading range of the RFID tag reader and writer and the arrangement position of the RFID tag.

FIG. 9B is a diagram illustrating a relationship between the reading range of the RFID tag reader and writer and the arrangement position of the RFID tag.

FIG. 10 is a flowchart illustrating a sequence of RFID tag determining according to the first embodiment.

FIG. 11 is a flowchart illustrating a sequence of data acquiring according to the first embodiment.

FIG. 12 is a diagram illustrating the configuration of an RFID tag reader and writer according to a second embodiment.

FIG. 13 is a diagram illustrating an example of a telegraph format when an EPC list is transmitted.

FIG. 14 is a flowchart illustrating a sequence of RFID tag determining according to the second embodiment.

FIG. 15 is a flowchart illustrating a sequence of data acquiring according to the second embodiment.

FIG. 16 is a diagram schematically illustrating an exemplary arrangement configuration of two antennas.

### DETAILED DESCRIPTION

Hereinafter, an information processing apparatus, a wireless tag reading apparatus, and a wireless tag reading method according to an embodiment of the invention will be described in detail with reference to the accompanying drawings. The invention is not limited to the embodiments described below.

### First Embodiment

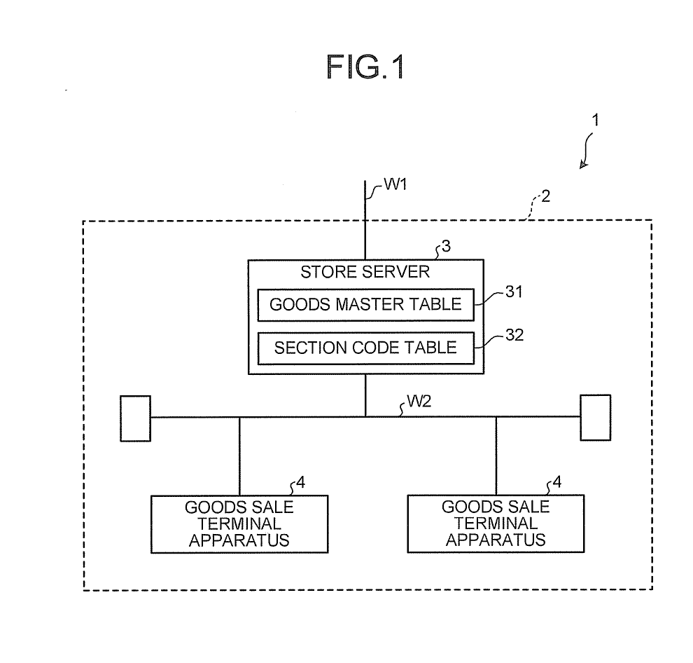

FIG. 1 is a diagram illustrating the configuration of a goods sale system 1 according to a first embodiment. As shown in FIG. 1, the goods sale system 1 serving as an information processing system includes a store system 2. The store system 2 is connected to another apparatus (for example, a headquarter system of a POS) via an electric communication line W1 such as a public network or an internet VPN (Virtual Private Network).

The store system 2 includes a store server 3 and goods sale terminal apparatuses 4 serving as an information processing apparatus. The store server 3 and the goods sale terminal apparatuses 4 are connected to each other via an electric communication line W2 such as a LAN (Local Area Network).

The store server 3 is a main computer that is in charge of the store system 2 and manages goods information regarding respective goods sold in the store. Specifically, the store server 3 stores a goods master table 31 used to manage the goods information regarding the respective goods and a section code table 32 in a storage medium (not shown).

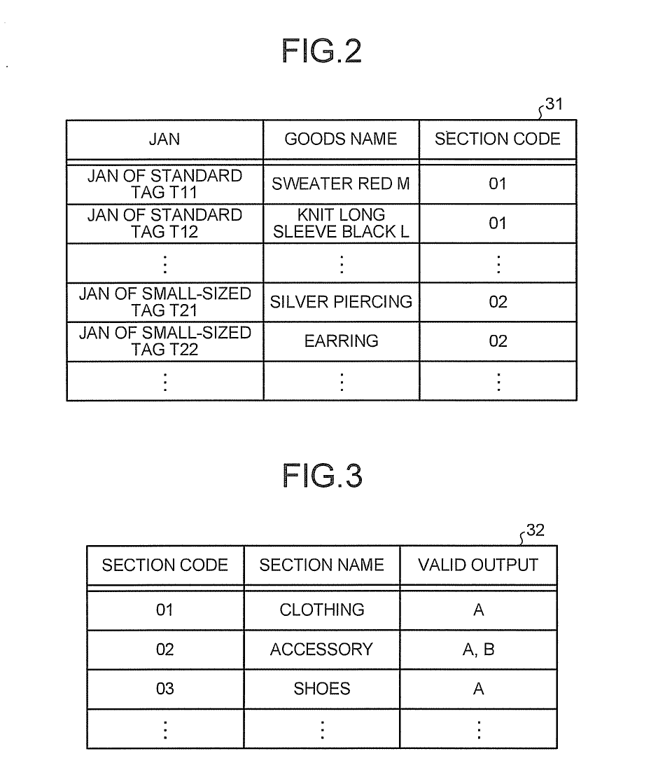

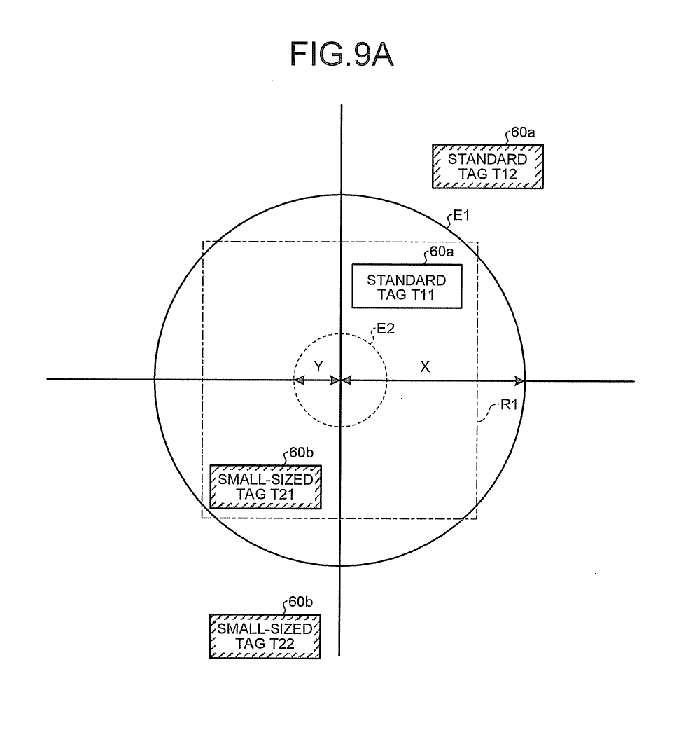

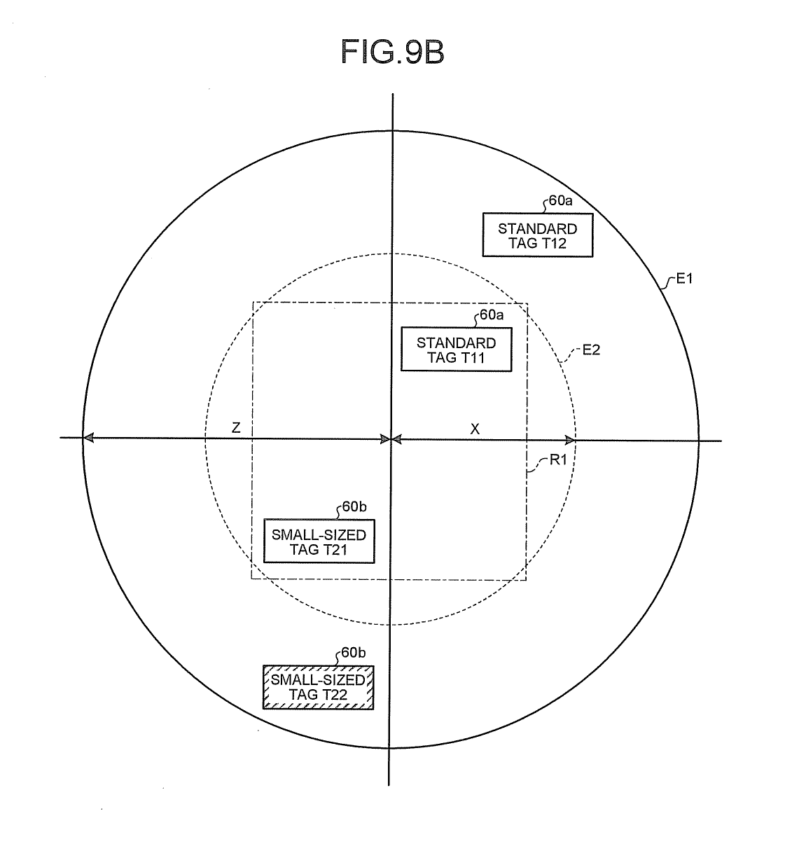

FIG. 2 is a diagram illustrating an example of the goods master table 31. As shown in FIG. 2, the goods master table 31 stores a JAN (Japanese Article Number) serving as a goods identification code for identifying respective goods, a goods name of the goods, and a section code indicating a classification of the goods in association with each other. The information maintained in the goods master table 31 is not limited to the example in FIG. 2, but other information (for example, unit cost or the like) may be maintained in associated with the JAN. Standard tags T11 and T12 and small-sized tags T21 and T22 shown in the JAN correspond to RFID tags 60a and 60b shown in FIGS. 9A and 9B described below. The goods identification code is not limited to the JAN, but a UPC (Universal Product Code), an EAN (European Article Number), or the like may be used.

FIG. 3 is a diagram illustrating an example of the section code table 32. As shown in FIG. 3, the section code table 32 maintains each section code, a section name, and a valid output in association with each other. Here, the valid output indicates a transmission output level validating a reading operation of information in the information read from the RFID tag 60 using plural kinds of transmission output levels described below. For example, as for goods of a section code “01” (section name “clothing”), the valid output indicates that reading the information as a transmission output level “A” is valid. As for goods of a section code “02” (section name “accessory”), the valid output indicates that reading the information as transmission output levels “A” and “B” is valid. Moreover, the valid output is set based on the magnitude of an electric field formed in a predetermined region (region R1 described below) by irradiation of radio waves at each transmission output level and the magnitude of an electric field with which the RFID tag 60 attached to the goods of each section code can respond.

Thus, the section code table 32 has a function of a filtering table in which information read from the RFID tag 60 at each transmission output level is selected. In this embodiment, the transmission output levels of the RFID reader and writer 50 are set to two stages of “A” and “B” (where A<B) according to the kinds (response distances) of the RFID tag 60 to be used, but the invention is not limited thereto.

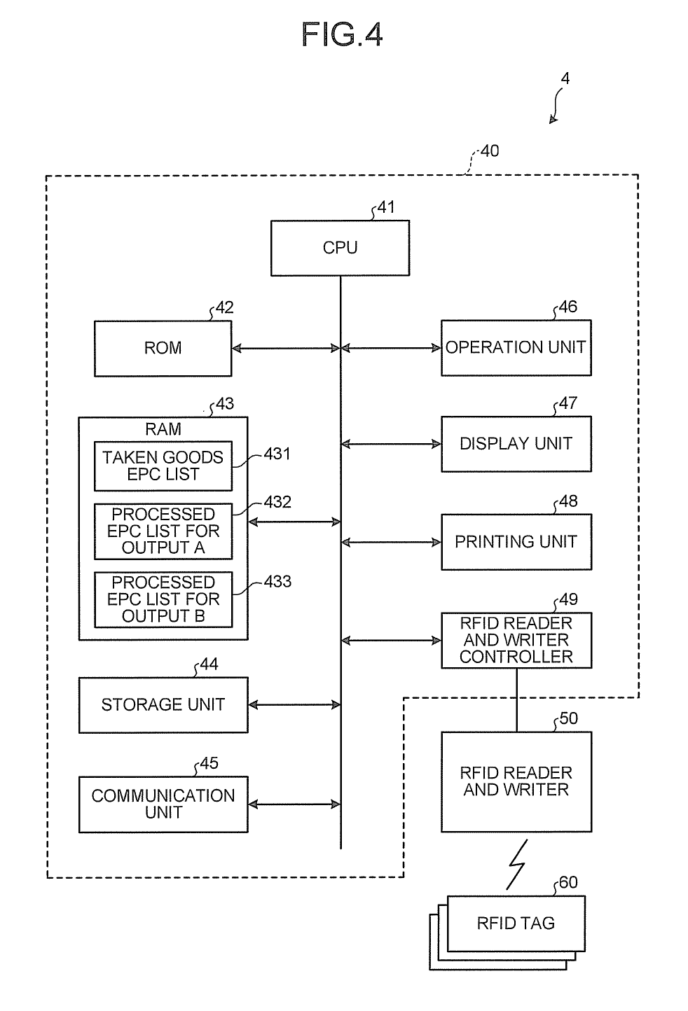

FIG. 4 is a diagram illustrating an example of the goods sale terminal apparatus 4. As shown in FIG. 4, the goods sale terminal apparatus 4 serving as an information processing apparatus includes a POS terminal 40 and an RFID reader and writer 50 serving as a wireless tag reading apparatus.

The POS terminal 40 includes a CPU (Central Processing Unit) 41, a ROM (Read-Only Memory) 42, a RAM (Random Access Memory) 43, a storage unit 44, a communication unit 45, an operation unit 46, a display unit 47, a printing unit 48, and an RFID reader and writer controller 49.

The CPU 41 controls the entire operation of the POS terminal 40 by executing various kinds of computer-readable programs stored in the ROM 42 or the storage unit 44. The ROM 42 stores various kinds of programs executed by the CPU 41 or setting information.

The RAM 43 functions as a work memory of the CPU 41 or the RFID reader and writer controller 49. Specifically, the RAM 43 stores, as data associated with RFID tag determining described below, a taken goods EPC list 431, processed EPC lists (a processed EPC list 432 for output A and a processed EPC list 433 for output B) for output P according to each transmission signal level (where “P” corresponds to each transmission output level).

The storage unit 44 includes a storage medium such as an HDD or a flash memory. The storage medium stores various kinds of programs executed by the CPU 41 or setting information. In this embodiment, the taken goods EPC list 431, the processed EPC list 432 for output A, and the processed EPC list 433 for output B used in the RFID tag determining described below are stored in the RAM 43, but the invention is not limited thereto. Instead, the taken goods EPC list 431, the processed EPC list 432 for output A, and the processed EPC list 433 for output B may be stored in the storage unit 44.

The communication unit 45 controls data communication with another apparatus connected via the electric communication line W1 or W2. The operation unit 46 includes an input device such as a keyboard, a touch panel, and various kinds of buttons and notifies the CPU 41 of an operation signal according to the operation details of the input device. The display unit 47 includes displays for an operator and a customer such as an LCD and displays characters or the like according to display data supplied from the CPU 41 by controlling the displays. The printing unit 48 includes a printing apparatus such as a receipt printer. The printing unit 48 performs receipt printing or journal printing based on print data from the CPU 41 by controlling driving of the printing apparatus.

The RFID reader and writer controller 49 outputs a signal to control the RFID reader and writer 50 according to an instruction signal output from the CPU 41. The RFID reader and writer 50 operates as an RFID reader or an RFID writer based on a signal input from the RFID reader and writer controller 49, reads or writes data from or to the RFID tag 60, and then notifies the CPU 41 of the read data.

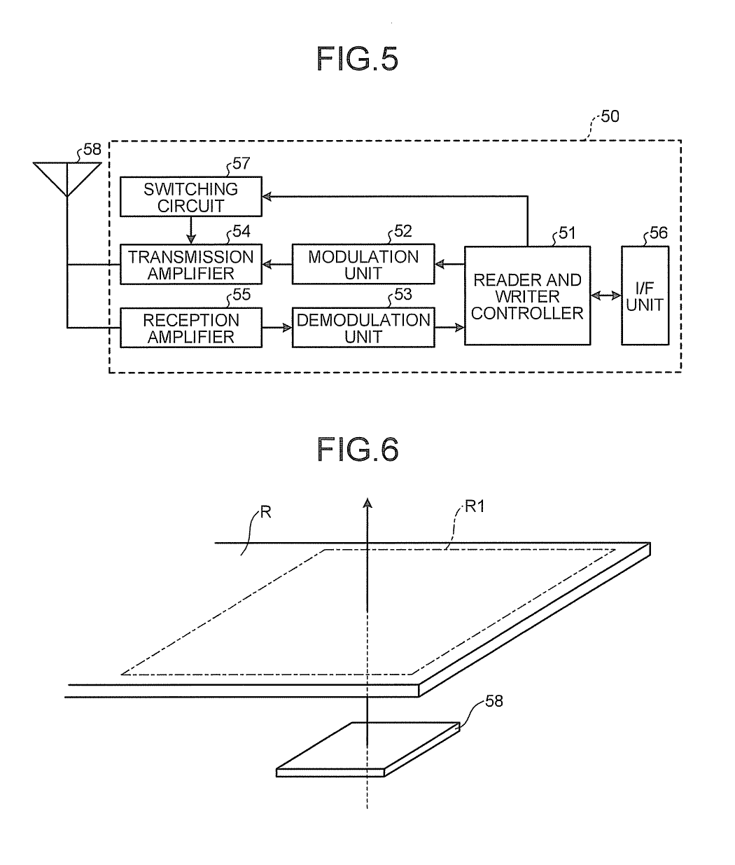

FIG. 5 is a diagram illustrating the configuration of the RFID reader and writer 50. As shown in FIG. 5, the RFID reader and writer 50 includes a reader and writer control unit 51, a modulation unit 52, a demodulation unit 53, a transmission amplifier 54, a reception amplifier 55, an interface unit 56, a switching circuit 57, and an antenna 58.

The reader and writer control unit 51 controls the operation of the RFID reader and writer 50 according to a control signal input from the RFID reader and writer controller 49 via the interface unit 56. The modulation unit 52 modulates transmission data received from the reader and writer control unit 51. The transmission amplifier 54 amplifies radio waves modulated by the modulation unit 52 and emits the amplified radio waves via the antenna 58. The reception amplifier 55 amplifies the radio waves received via the antenna 58. The demodulation unit 53 demodulates the radio waves amplified by the reception amplifier 55. The interface unit 56 performs data communication with the RFID reader and writer controller 49.

The switching circuit 57 has a D/A conversion function of converting a digital control signal input from the CPU 41 (the RFID reader and writer controller 49) into an analog signal (current value). The transmission amplifier 54 includes a power amplifier changing a transmission output (transmission power) level of the radio waves emitted from the antenna 58 according to the analog signal (current value) from the switching circuit 57.

The antenna 58 is an RFID antenna communicating with the RFID tag 60 which is a non-contact type wireless tag. As shown in FIG. 6, the antenna 58 is disposed below a register counter R installed in a checkout area of a store. The directivity of the antenna is oriented upward from the register counter R (an arrow direction in FIG. 6). The valid range of the radio waves emitted from the antenna 58 is set to contain a region R1 above the register counter R for each transmission output level according to the response distances of the RFID tags 60a and 60b described below. In the RFID reader and writer 50, the reader and writer control unit 51 performs communication with the RFID tag 60 attached to each of the goods in a non-contact manner and reads the data stored in the RFID tag 60 (an IC chip 62 described below) when the goods purchased by a customer are put within the region R1 of the register counter R.

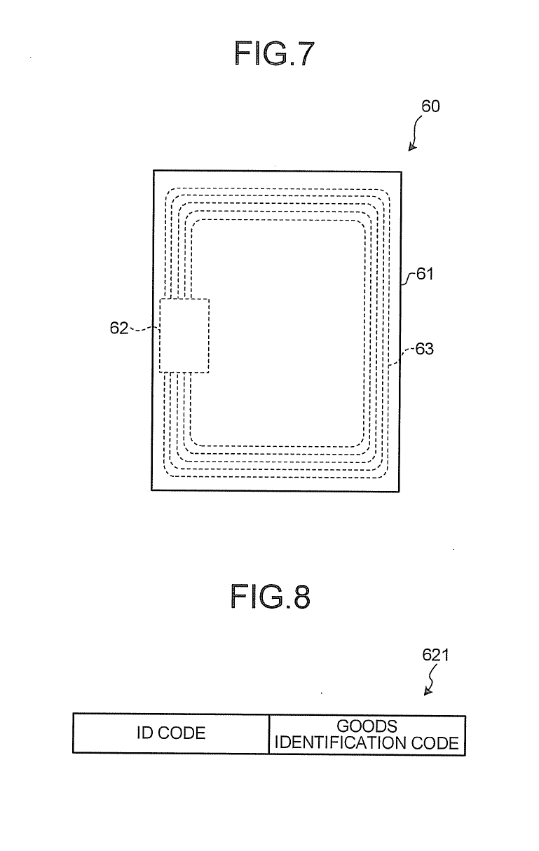

FIG. 7 is a diagram illustrating the configuration of the RFID tag 60. The RFID tag 60 includes the IC chip 62 and an antenna 63 within a cover body 61 formed of a case or a cover. The IC chip 62 is an electronic circuit component that includes a power generation unit, a modulation unit, a demodulation unit, a memory unit 621 (see FIG. 8), and a control unit controlling the power generation unit, the modulation unit, the demodulation unit, and the memory unit. The power generation unit rectifies and stabilizes the radio waves received via the antenna 63 and supplies power to each unit of the IC chip 62. The demodulation unit demodulates the radio waves received via the antenna 63 and transmits the demodulated radio waves to the control unit. The modulation unit modulates the data sent from the control unit into radio waves and the modulated radio waves are emitted from the antenna 63. The control unit writes the data demodulated by the demodulation unit into the memory unit 621 or reads the data from the memory unit 621, and then sends the modulation unit the data.

As shown in FIG. 8, the memory unit 621 has a region storing an ID code (serial number) unique to each RFID tag 60 and a region storing a goods identification code such as a JAN (Japanese Article Number), an EPC (Electronic Product Code), or an SGTIN (Serialized Global Trade Item number). In this embodiment, it is assumed that the memory unit 621 stores the ID code and the EPC including the JAN.

In this embodiment, it is assumed that two kinds of RFID tags 60 with different response distances are used. Here, the response distance refers to a limit distance (communication distance) in which the RFID tag 60 can respond to the radio waves with the predetermined strength of the electric field (transmission output level) emitted from the antenna 58. Hereinafter, the RFID tag 60 with a longer response distance is referred to as an “RFID tag 60a” and the RFID tag 60 with a shorter response distance is referred to as an “RFID tag 60b.”

However, when the RFID tags 60 with different response distances are used together and the transmission output level of the radio waves is constant, there is a possibility that all of the RFID tags 60 present in the region R1 shown in FIG. 6 may not be read or an unnecessary RFID tag 60 in the periphery of the region R1 may be read due to the difference between the response distances. Hereinafter, this problem will be described with reference to FIGS. 9A and 9B.

FIGS. 9A and 9B are diagrams illustrating relationships between the reading range of the RFID reader and writer 50 and the arrangement position of the RFID tag 60. Here, a region R1 corresponds to the region R1 on the register counter R shown in FIG. 6. The RFID tags 60a and 60b are disposed within the region R1 and in the periphery of the region R1. It is assumed that a response distance of the RFID tag 60a for the radio waves with the same strength of the electric field emitted from the antenna 58 (the center of the region R1) is “X” and the response distance of the RFID tag 60b is “Y” (where X>Y).

Here, when it is assumed that the transmission output level of the RFID reader and writer 50 is “A”, a radiation range of the strength of the electric field in which the RFID tag 60a can respond is E1 (radius X), and a radiation range of the strength of the electric field in which the RFID tag 60b can respond is E2 (radius Y), the RFID reader and writer 50 can read only the RFID tag 60a (the standard tags T11) falling within the radiation range E1, as shown in FIG. 9A. Moreover, the RFID reader and writer 50 may not read the RFID tag 60b (the small-sized tag T21) falling within the region R1 due to the restriction on the response distance “Y”. In FIG. 9A (FIG. 9B), the RFID tag 60 which may not be read by the RFID reader and writer 50 is identified by hatching.

It is assumed that a transmission output level “B” is larger than the transmission output level “A” of the RFID reader and writer 50. As shown in FIG. 9B, it is also assumed that a radiation range of the strength of the electric field in which the RFID tag 60a can respond is E1 (radius Z, where Z>X) and a radiation range of the strength of the electric field in which the RFID tag 60b can respond is E2 (radius X). At this time, since the radiation range E2 is expanded, the RFID reader and writer 50 can read the RFID tag 60a (the standard tag T11) and the RFID tag 60b (the small-sized tag T21) disposed in the region R1. However, since the expanded radiation range E1 reaches up to the RFID tag 60a (the standard tag T12) in the periphery of the region R1, the RFID reader and writer 50 may read the unnecessary RFID tag 60a.

Accordingly, the CPU 41 according to this embodiment allows the RFID reader and writer 50 to alternately radiate the radio waves with different transmission output levels and properly select the goods code read with the respective transmission output levels according to the valid outputs of the section code table 32, so that the RFID tags 60a and 60b disposed in the region R1 can reliably be read. Hereinafter, RFID tag determining performed by the POS terminal 40 will be described.

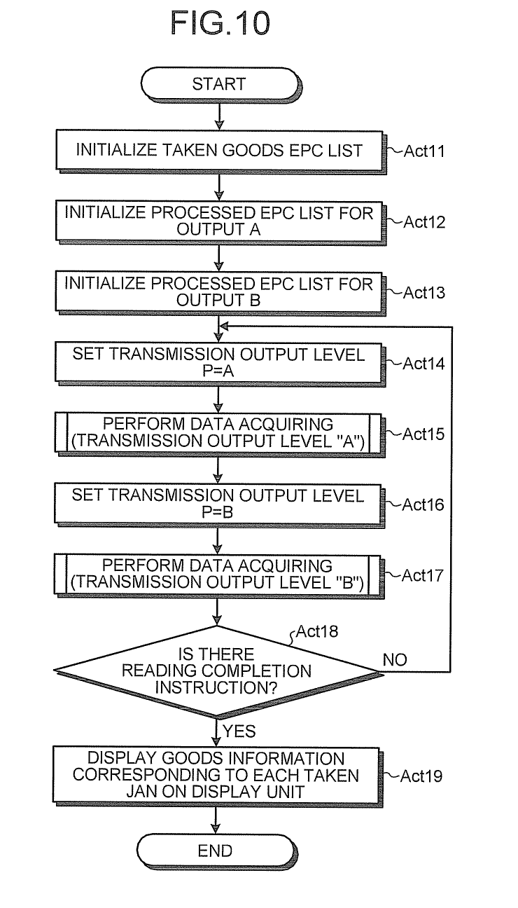

FIG. 10 is a flowchart illustrating a sequence of the RFID tag determining. In this process, it is supposed that the goods purchased by a customer are put on the register counter R (the region R1).

First, the CPU 41 initializes the taken goods EPC list 431 (Act 11) and initializes the processed EPC list 432 for output A and the processed EPC list 433 for output B (Act 12 and Act 13).

Subsequently, the CPU 41 sets the transmission output level of the RFID reader and writer 50 to “A” by notifying the RFID reader and writer controller 49 that “A” is used as the transmission output level P (Act 14). At this time, in the RFID reader and writer 50, the transmission amplifier 54 is controlled via the interface unit 56, the reader and writer control unit 51, and the switching circuit 57, so that the transmission output level of the RFID reader and writer 50 is set to “A”.

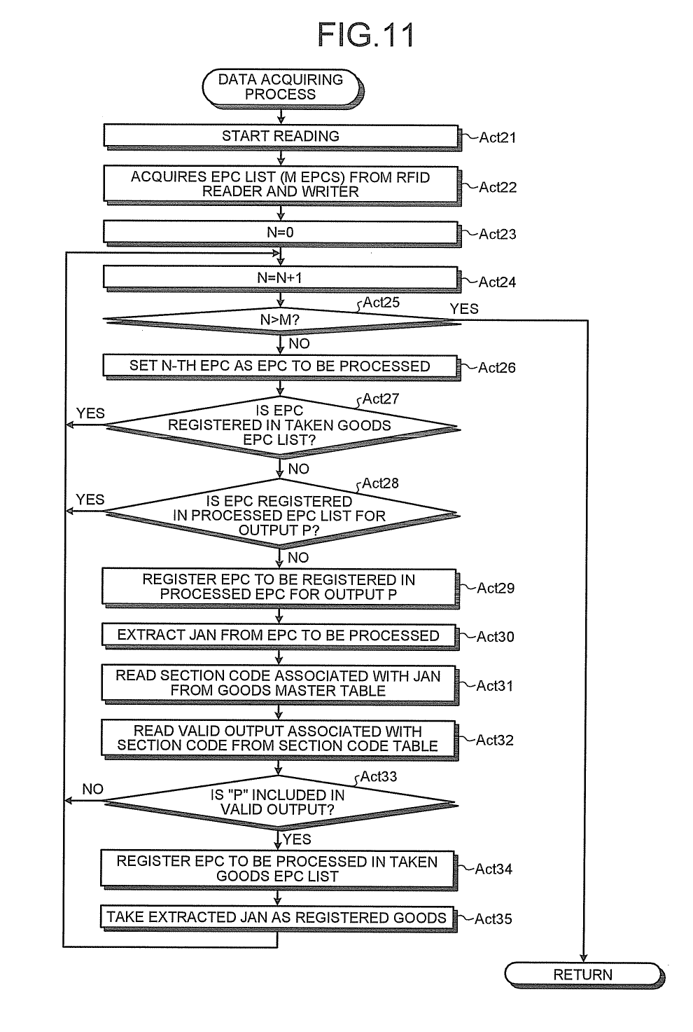

Subsequently, the CPU 41 performs the data acquiring using the transmission output level “A” (Act 15). Hereinafter, the data acquiring of Act 15 will be described with reference to FIG. 11.

FIG. 11 is a flowchart illustrating a sequence of data acquiring. First, the CPU 41 allows the RFID reader and writer 50 to read the RFID tag 60 by outputting a signal instructing the RFID reader and writer 50 to start reading via the RFID reader and writer controller 49 (Act 21).

The reader and writer control unit 51 of the RFID reader and writer 50 emits the radio waves according to a set transmission output level from the antenna 58 by outputting a digital signal with the set transmission output level to the switching circuit 57 according to the instruction signal of the CPU 41. Each of the RFID tags 60 receiving the radio waves from the RFID reader and writer 50 transmits the EPC stored in the memory unit 621 as a response signal to the RFID reader and writer 50. Then, the RFID reader and writer 50 transmits a list of the EPCs (hereinafter, referred to as an EPC list) read from the respective RFID tags 60 to the POS terminal 40 (the CPU 41).

The CPU 41 acquires the EPC list transmitted from the RFID reader and writer 50 via the RFID reader and writer controller 49 (Act 22). Subsequently, if the CPU 41 initializes a parameter N to “0” to specify an EPC to be processed (Act 23), the CPU 41 increases the value of N by one (Act 24), and then the process proceeds to Act 25.

In Act 25, the CPU 41 determines whether the value of the current N exceeds the number M of EPCs included in the EPC list acquired in Act 22. Here, if the CPU 41 determines that the value of N is equal to or less than M (No in Act 25), the CPU 41 sets the N-th EPC to an EPC to be processed (Act 26) and determines whether this EPC is registered in the taken goods EPC list 431 based on uniformity of the EPC (ID code) (Act 27).

If the CPU 41 determines that the EPC to be processed is registered in the taken goods EPC list 431 in Act 27 (Yes in Act 27), the CPU 41 allows the process to return to Act 24. If the CPU 41 determines that the EPC to be processed is not registered in the taken goods EPC list 431 in Act 27 (No in Act 27), the CPU 41 determines whether the EPC to be processed is registered in the processed EPC list for output P based on the uniformity of the EPC (ID code) (Act 28). Here, “P” of the processed EPC list for output P corresponds to the currently set transmission output level. For example, when the transmission output level “A” is set, the processed EPC list for output P corresponds to the processed EPC list 432 for output A. In addition, when the transmission output level “B” is set, the processed EPC list for output P correspond to the processed EPC list 433 for output B. That is, the CPU 41 switches between the processed EPC list 432 for output A and the processed EPC list 433 for output B according to the currently set output level.

If the CPU 41 determines that the EPC to be processed is registered in the processed EPC list for output P in Act 28 (Yes in Act 28), the CPU 41 allows the process to return to Act 24. On the other hand, if the CPU 41 determines that the EPC to be processed is not registered in the processed EPC list for output P in Act 28 (No in Act 28), the CPU 41 registers the EPC to be processed in the processed EPC list for output P (Act 29).

Subsequently, if the CPU 41 extracts the JAN from the EPC to be processed (Act 30), the CPU 41 reads a section code associated with this JAN from the goods master table 31 of the store server 3 (Act 31). When the CPU 41 extracts the JAN from the EPC, a known technique (for example, an EPCglobal Tag Data Standard) is used.

Based on the section code read in Act 31, the CPU 41 reads the valid output corresponding to this section code from the section code table 32 (Act 32). Subsequently, the CPU 41 determines whether the currently set transmission output level “P” is included in the valid output read in Act 32 (Act 33). Here, when the transmission output level “A” is set, “P” of Act 33 becomes “A”. In addition, when the transmission output level “B” is set, “P” becomes “B”.

If the CPU 41 determines that the transmission output level “P” is not included in the valid output in Act 33 (No in Act 33), the CPU 41 allows the process to return to Act 24. On the other hand, if the CPU 41 determines that the transmission output level “P” in Act 32 is included in the valid output (Yes in Act 33), the CPU 41 registers the EPC to be processed in the taken goods EPC list 431 (Act 34). Then, the CPU 41 takes the JAN extracted in Act 30 as registered goods (Act 35) and allows the process to return to Act 24.

On the other hand, if the CPU 41 determines that the value of N exceeds M in Act 25 (Yes in Act 25), the CPU 41 terminates the data acquiring. Then, the process returns to the process in FIG. 10.

Referring back to FIG. 10, if the CPU 41 completes the data acquiring of Act 15, the CPU 41 sets the transmission output level of the RFID reader and writer 50 to “B” notifying the RFID reader and writer controller 49 that “B” is used as the transmission output level P (Act 16). At this time, in the RFID reader and writer 50, the transmission amplifier 54 is controlled via the interface unit 56, the reader and writer control unit 51, and the switching circuit 57, so that the transmission output level of the RFID reader and writer 50 is set to “B”.

Subsequently, the CPU 41 performs the data acquiring using the transmission output level “B” (Act 17). Moreover, since the data acquiring of Act 17 is the same as the data acquiring of Act 15, the description thereof will not be repeated.

If the CPU 41 completes the data acquiring of Act 17, the CPU 41 determines whether an operation signal used to instruct the completion of the reading is transmitted from the operation unit 46 (Act 18). Here, if the CPU 41 determines that the operation signal used to instruct the completion of the reading is not transmitted (No in Act 18), the process returns to Act 14 and the reading at the transmission output levels “A” and “B” are performed in a time division manner. If the CPU 41 determines that the operation signal used to instruct the completion of the reading is transmitted in Act 18 (Yes in Act 18), the CPU 41 reads the goods information associated with each JAN taken as the registered goods from the goods master table 31, displays the goods information on the display unit 47 (Act 19), and then terminates the process.

Hereinafter, an example of the RFID tag determining described above will be described with reference to FIGS. 9A and 9B. It is assumed that the RFID tag 60 read by the RFID reader and writer 50 is only the “standard tag T11”, as in FIG. 9A, in the data acquiring (the transmission output level “A”) of Act 15. At this time, since the valid output of the section code corresponding to the JAN of the “standard tag T11” includes “A” (see FIGS. 2 and 3), the JAN of the “standard tag T11” is taken as the registered goods.

Next, it is assumed that the RFID tags 60 read by the RFID reader and writer 50 are the “standard tag T11”, the “standard tag T12”, and the “small-sized tag T21”, as in FIG. 9B, in the data acquiring (the transmission output level “B”) of Act 17. At this time, since the EPC of the “standard tag T11” is already registered in the taken goods EPC list 431 in the data acquiring of Act 15, any registered goods are not taken. Moreover, since “B” is not included in the valid output of the section code corresponding to the JAN of the “standard tag T12” in the EPC of the “standard tag T12”, any registered goods are not taken. Furthermore, since “B” is included in the valid output of the section code corresponding to the JAN of the “small-sized tag T21” in the EPC of the “small-sized tag T21” (see FIGS. 2 and 3), the JAN of the “small-sized tag T21” is taken as the registered goods.

From the results of the data acquiring of Act 15 and Act 17, only the EPCs (JANs) of the RFID tags 60 (the standard tag T11 and the small-sized tag T21) present within the region R1 are taken as the goods identification code of the registered goods.

According to the first embodiment, as described above, the RFID reader and writer 50 alternately emits the radio waves with the different transmission output levels and selects the goods codes taken at the respective transmission output levels according to the valid output registered in the section code table 32. Therefore, the RFID tags 60a and 60b disposed in the region R1 can reliably be read. With such a configuration, since it is not necessary to change the arrangement positions of the goods disposed in the region R1 and the time taken to read the RFID tag 60 can be shortened, it is possible to effectively read the RFID tags 60a and 60b disposed in the region R1. Moreover, equalization can be achieved so that the RFID tags with the different response distances respond at the same response distance.

### Second Embodiment

Next, a second embodiment will be described. In the above-described first embodiment, the case is hitherto described in which the POS terminal 40 (the CPU 41) changes the transmission output level of the RFID reader and writer 50. In this embodiment, a case will be described in which the RFID reader and writer itself changes the transmission output level. The same reference numerals are given to the same constituent elements as those of the first embodiment, and the description thereof will not be repeated.

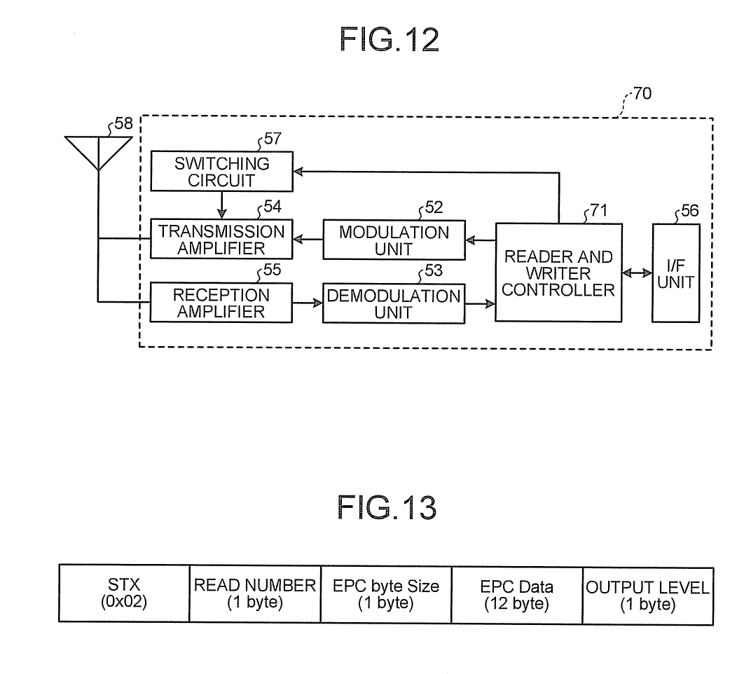

FIG. 12 is a diagram illustrating the configuration of an RFID reader and writer 70 according to this embodiment. As shown in FIG. 12, the RFID reader and writer 70 includes a reader and writer control unit 71, a modulation unit 52, a demodulation unit 53, a transmission amplifier 54, a reception amplifier 55, an interface unit 56, a switching circuit 57, and an antenna 58.

The reader and writer control unit 71 controls the operation of the RFID reader and writer 70 according to a control signal from the RFID reader and writer controller 49 input via the interface unit 56. Moreover, the reader and writer control unit 71 switches a digital signal used to instruct different transmission output levels at a predetermined time interval and outputs the digital signal to the switching circuit 57. Thus, the analog signal (current value) corresponding to the digital signal is transmitted from the reader and writer control unit 71 to the switching circuit 57 and the transmission amplifier 54 switches the transmission output (transmission power), so that the radio waves of the respective transmission output levels are emitted in a time division manner from the antenna 58. As in the first embodiment, it is assumed that digital signals indicating the transmission output levels “A” and “B” are alternately output in this embodiment.

The reader and writer control unit 71 transmits the data input from the demodulation unit 53 according to the switch of the transmission output level, that is, the EPC list, in which the values of the transmission output levels used in reading the EPC are associated with the EPCs read from the respective RFID tags 60, to the POS terminal 40 via the interface unit 56. Here, a telegraph format used to transmit the EPC list from the RFID reader and writer 50 to the POS terminal 40 is not particularly limited. For example, a telegraph format shown in FIG. 13 may be used.

FIG. 13 is a diagram illustrating an example of a telegraph format used to transmit the EPC list. As shown in FIG. 13, the telegraph format includes a syntax “STX” indicating that the telegraph format is used to transmit the EPC list, a “read number” in which the number of read EPCs is stored, an “EPC byte Size” in which the EPC size of each EPC is stored, “EPC Data” in which the EPC itself is stored, and an “output level” in which the transmission output level is stored when the reading is performed. The “EPC byte Size”, the “EPC Data”, and the “output level” are output for each EPC when the reading is performed.

When the above telegraph format is used and, for example, when EPC “303500000000000000000001” is read from a given RFID tag 60 at the transmission output level “A” and EPC “303500000000000000000002” is read from a given RFID tag 60 at the transmission output level “B”, the reader and writer control unit 71 transmits “02 02 0C 303500000000000000000001 01 0C 303500000000000000000002 02” to the POS terminal 40. Here, the transmission output level “A” is expressed as “01” and the transmission output level “B” is expressed as “02”.

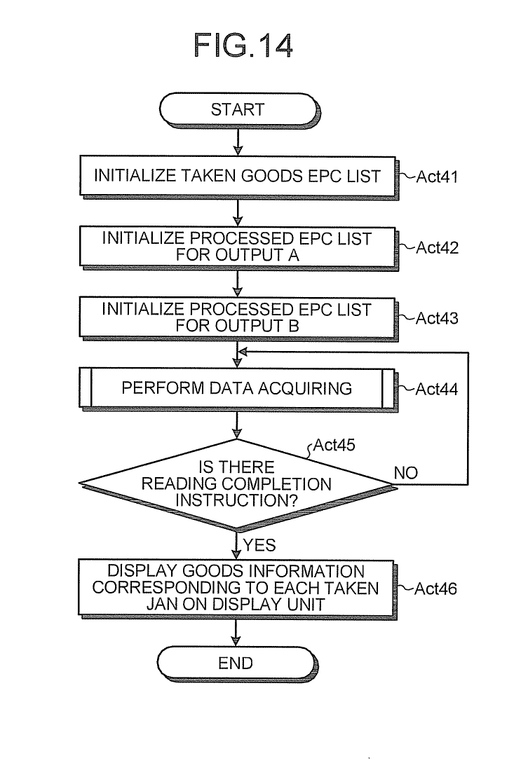

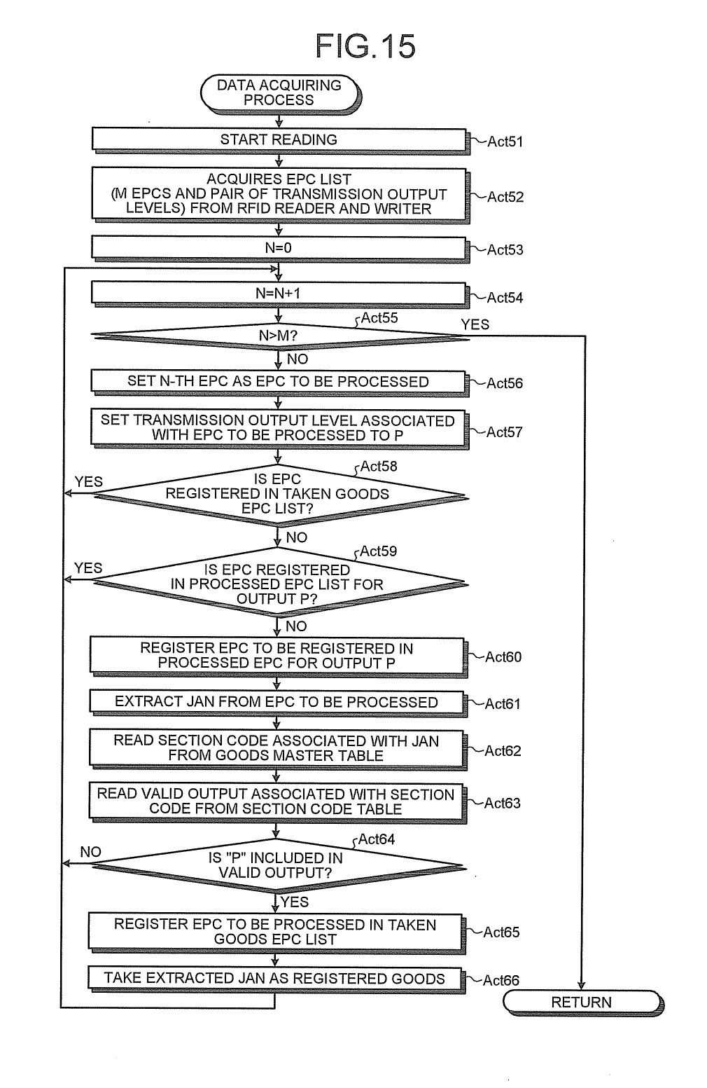

Hereinafter, the RFID tag determining according to this embodiment will be described with reference to FIGS. 14 and 15. FIG. 14 is a flowchart illustrating the sequence of the RFID tag determining according to this embodiment. In this process, it is supposed that the goods purchased by a customer are put on the register counter R (the region R1).

First, the CPU 41 initializes the taken goods EPC list 431 (Act 41) and initializes the processed EPC list 432 for output A and the processed EPC list 433 for output B (Act 42 and Act 43).

Subsequently, the CPU 41 performs data acquiring (Act 44). Hereinafter, the data acquiring of Act 44 will be described with reference to FIG. 15.

First, the CPU 41 allows the RFID reader and writer 70 to read the RFID tag 60 by outputting a signal instructing the RFID reader and writer 70 to start reading via the RFID reader and writer controller 49 (Act 51).

The reader and writer control unit 71 of the RFID reader and writer 70 emits the respective radio waves with the strengths of the electric fields corresponding to the transmission output level “A” and “B” from the antenna 58 in a time division manner by outputting the two digital signals instructing the transmission output levels “A” and “B” to the switching circuit 57 while alternately switching the two digital signals according to the instruction signals from the CPU 41. Each of the RFID tags 60 receiving the radio waves from the RFID reader and writer 70 transmits the EPC stored in the memory unit 621 as a response signal to the RFID reader and writer 70. Then, the reader and writer control unit 71 generates the EPC list in which the EPCs read from the respective RFID tags 60 are associated with the transmission output levels used in this reading and transmits the EPC list to the POS terminal 40 (the CPU 41) using the predetermined telegraph format shown in FIG. 13.

The CPU 41 acquires the EPC list transmitted from the RFID reader and writer 70 via the RFID reader and writer controller 49 (Act 52). Subsequently, if the CPU 41 initializes a parameter N to “0” to specify an EPC to be processed (Act 53), the CPU 41 increases the value of N by one (Act 54), and then the process proceeds to Act 55.

In Act 55, the CPU 41 determines whether the value of the current N exceeds the number M of EPCs included in the EPC list acquired in Act 52. Here, if the CPU 41 determines that the value of N is equal to or less than M (No in Act 55), the CPU 41 sets the N-th EPC to an EPC to be processed (Act 56) and sets the transmission output level associated with the EPC to be processed to the parameter “P” indicating the transmission output level (Act 57). Since the processes of Act 58 to Act 66 are the same as the processes from Act 27 to Act 35 of the data acquiring described with reference to FIG. 11, the description thereof will not be repeated.

Referring back to FIG. 14, if the CPU 41 completes the data acquiring of Act 44, the CPU 41 determines whether an operation signal indicating the completion of the reading is transmitted from the operation unit 46 (Act 45). Here, if the CPU 41 determines that the operation signal indicating the completion of the reading is not transmitted (No in Act 45), the process returns to Act 44. On the other hand, if the CPU 41 determines that the operation signal indicating the completion of the reading is transmitted in Act 45 (Yes in Act 45), the CPU 41 reads the goods information associated with each JAN taken as the registered goods from the goods master table 31, displays the goods information on the display unit 47 (Act 46), and then terminates the process.

As described above, the same advantages as those of the above-described first embodiment can be obtained according to the second embodiment. Since the RFID reader and writer 70 spontaneously switches the transmission output levels, the load on the POS terminal 40 (the CPU 41) can be reduced.

Although the embodiments are hitherto described, the invention is not limited thereto, but may be modified, substituted, and added in various forms without departing from the scope of the invention.

For example, in the above-described embodiments, transmission output levels are switched into two stages according to the different kinds of RFID tags with different response distances, but the invention is not limited thereto. The transmission output levels are preferably switched according to the number of stages corresponding to the kinds (response distances) of the RFID tags 60 used together. Moreover, the transmission output levels are set so that the radio waves with the strengths of the electric fields in which the RFID tags 60 can respond are emitted within the region R1 according to the kinds of RFID tags 60.

In the above-described embodiments, the CPU 41 of the POS terminal 40 mainly performs the RFID tag determining, but the invention is not limited thereto. Instead, the RFID reader and writer controller 49 may perform the RFID tag determining.

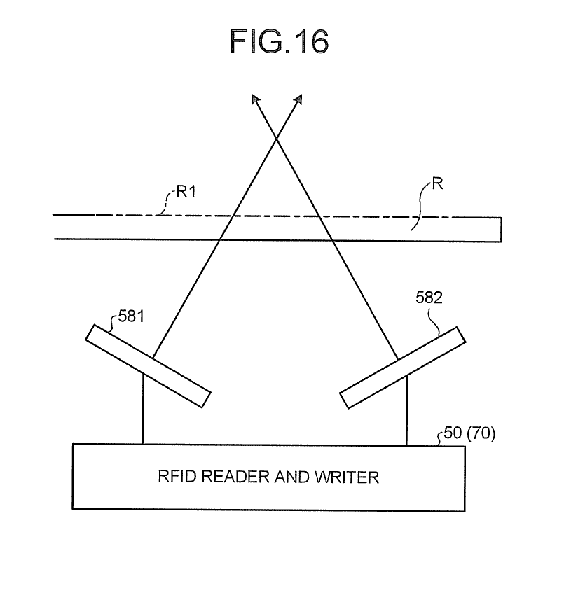

In the above-described embodiments, the radio waves with the different transmission output levels are alternately emitted from one antenna 58, but the invention is not limited thereto. Instead, the radio waves with the different transmission output levels may alternately be emitted from a plurality of antennas corresponding to the number of transmission output levels, respectively. FIG. 16 is a diagram schematically illustrating an exemplary configuration of two antennas (antennas 581 and 582). As shown in FIG. 16, the antennas 581 and 582 are disposed below the register counter R and the radio waves with the transmission output levels “A” and “B” are alternately emitted to above (direction of an arrow in FIG. 16) the register counter R from the two antennas. In FIG. 16, the radio waves with the transmission output level “A” are emitted from the antenna 581 and a valid range of the radio waves is set to include the region R1 on the register counter R at the strength of the electric field in which the RFID tag 60a can respond. Moreover, the radio waves with the transmission output level “B” are emitted from the antenna 582 and the valid range of the radio waves is set to include the region R1 on the register counter R at the strength of the electric field in which the RFID tag 60b can respond.

In the above-described embodiments, the POS terminal 40 performs the data acquiring, but the invention is not limited thereto. The RFID reader and writer 50 may include a function unit of the POS terminal 40 associated with the data acquiring and the RFID reader and writer 50 may singularly perform the data acquiring as an information processing apparatus.

A program executed in the POS terminal 40 according to the above-described embodiments is provided in a state where the program is stored in advance in a recording medium such as the ROM 42 of the POS terminal 40. However, the invention is not limited thereto. The program may be stored in a recording medium such as a CD-ROM, a flexible disk (FD), a CD-R, or a DVD in a form of a file which can be installed or executed.

The program may be stored in a computer connected to a network such as the Internet and may be provided by downloading the program via the network. Moreover, the program may be provided or distributed via a network such as the Internet.

What is claimed is:

1. An information processing apparatus comprising:
a reading unit emitting radio waves to a predetermined region and reading information from wireless tags responding to the radio waves;
an output level control unit changing output levels of the radio waves emitted by the reading unit to values corresponding to the plural kinds of wireless tags with different response distances;
a storage unit storing a table in which the output levels validating the information read from the wireless tags are associated as valid outputs with respective kinds of wireless tag; and
a selection unit selecting the information read from the respective wireless tags based on the kinds of wireless tags communicating with the reading unit using the radio waves of the output levels and the valid outputs of the respective kinds of wireless tags stored in the table.

2. The apparatus according to claim 1,
wherein the wireless tag maintains goods information used to identify goods to which the wireless tag is attached, as information indicating a kind of wireless tag itself,
wherein the table stores goods information regarding goods to which the wireless tag is attached, as information indicating the kind of wireless tag itself, and
wherein the selection unit determines the kinds of wireless tags based on the goods information read from the wireless tags and selects the wireless tags validating the reading based on the kinds of wireless tags and the valid output of each of the goods information stored in the table.

3. The apparatus according to claim 2, further comprising:
a registration unit registering the goods information read from the wireless tags by the reading unit in a list,
wherein the selection unit selects the respective goods information registered in the list.

4. The apparatus according to claim 3,
wherein the registration unit switches the list which is a registration destination of the goods information for each output level of the radio waves used to read the goods information, and
wherein the selection unit selects the respective goods information registered in the list for each list corresponding to each output level.

5. The apparatus according to claim 3,
wherein the goods information includes tag identification information used to identify the wireless tag maintaining this good information, and
wherein whenever the reading unit reads new goods information, the registration unit determines whether the new goods information is registered in the list based on uniformity of the tag identification information included in the new goods information and each of the goods information registered in the list and registers the new goods information determined not to be registered in the list.

6. The apparatus according to claim 3,
wherein the table includes a first table in which the goods information of respective goods and section codes of the goods are associated with each other and are stored and a second table in which the valid outputs and the section codes are associated with each other and are stored, and
wherein the selection unit reads the section code corresponding to the goods information registered in the list from the first table and validates the goods information registered in the first table when the valid output of the second table associated with the read section code includes the currently set output level.

7. The apparatus according to claim 1, wherein the output level control unit allows the reading unit to emit the radio waves while switching the radio waves with the output levels at which the kinds of wireless tags can respond according to the kinds of wireless tags.

8. The apparatus according to claim 1, wherein the output level control unit periodically changes the output levels to values corresponding to the respective kinds of wireless tags.

9. A wireless tag reading apparatus comprising:
an antenna emitting radio waves including a signal used to read information maintained in wireless tags to a predetermined region which is a reading target;
a switching unit switching output levels of the radio waves emitted from the antenna into a plurality of stages;
a reading unit reading information via the antenna from each of the wireless tags responding to the respective radio waves with the output levels; and
a list generation unit generating a list in which the information read by the reading unit is associated with the output levels used to read the information.

10. A wireless tag reading method executed in an information processing apparatus including a reading unit which emits radio waves to a predetermined region and reads information from wireless tags responding to the radio waves, the method comprising:
changing output levels of the radio waves emitted by the reading unit into values corresponding to the plural kinds of wireless tags with different response distances; and
selecting the information read from the respective wireless tags based on a table, in which the output levels validating the information read from the wireless tags are associated as valid outputs with the respective kinds of wireless tags, and the kinds of wireless tags communicating with the reading unit using the radio waves of the output levels.
